(19) United States
(12) Patent Application Publication
(10) Pub. No.: US 2013/0079160 A1
(43) Pub. Date: Mar. 28, 2013

(54) VARIABLE STIFFNESS TORSIONAL COUPLING AND MACHINE USING SAME

(71) Applicant: Thomas Alan Brosowske, Dunlap, IL (US)

(72) Inventor: Thomas Alan Brosowske, Dunlap, IL (US)

(73) Assignee: CATERPILLAR INC., Peoria, IL (US)

(21) Appl. No.: 13/475,262

(22) Filed: May 18, 2012

Related U.S. Application Data
(63) Continuation-in-part of application No. 13/246,097, filed on Sep. 27, 2011.

(51) Int. Cl. F16D 3/80

(52) U.S. Cl. 464/27

(57) ABSTRACT

A variable stiffness torsional coupling includes a plurality of piston and barrel combinations that each define a variable volume chamber fluidly connected to a pressure control device. An electronic controller is in control communication with the pressure control device and configured to execute a resonance avoidance algorithm to generate pressure control signals to change the rotational stiffness of the coupling.

### RELATION TO OTHER PATENT APPLICATION

This application is a continuation in part of co-pending patent application Ser. No. 13/246,097, filed Sep. 27, 2011 entitled Radial Piston Damped Torsional Coupling And Machine Using Same.

### TECHNICAL FIELD

The present disclosure relates generally to torsional couplings, and more particularly to a variable stiffness torsional coupling with a resonance vibration avoidance strategy.

### BACKGROUND

Torsional couplings are often encountered between two rotating components that need the ability to provide come relative rotation to accommodate torsional vibrations. For instance, an engine may be utilized to drive a hydraulic piston pump in a fracture rig pumping application. In another example, an engine may be utilized to drive a generator. Other examples are too numerous to mention. A torsional coupling may be necessary to accommodate torsional vibrations resulting from engine harmonic excitations due to sequential engine cylinder firings, and torsional vibrations may also originate from the driven device, such as from a pump with each pump stroke of each cylinder. In addition, nature torsional frequencies of various components in the drive line may also be excited and in need of being absorbed and damped.

Co-owned U.S. Pat. No. 7,335,107 teaches a torsional coupling in which torques are transmitted from a first coupling element to a second coupling element by way of an interaction between radially oriented pistons of the first coupling element that are biased into contact with the circular arch surfaces of the second coupling element. Torsional vibrations are accommodated by the piston contact surface moving back and forth on the circular arc. This relative rotation between the first and second coupling elements results in movement of the piston into and out of its respective barrel. Some damping occurs due to the presence of lubricating fluid and friction at the piston contact with the second coupling element as well as with its respective barrel. While the '107 patent taught an innovative new type of torsional coupling, there remains room for improvement.

In one specific instance, torsional vibrations are known to be excited when an engine is started up and accelerates to an operational speed. Engineers have observed that a resonance torsional vibration frequency may be excited at some low engine speed during the start up procedure. Current strategies to deal with this resonance torsional vibration often include attempts to quickly accelerate the engine through the speed range associated with the resonance torsional vibration. The strategy assumes that the magnitude of the resonance torsional vibration can be kept manageable as long as the engine spends only a brief time in the speed range of concern. However, a resonance torsional vibration may still be excited and result in accelerated wear and fatigue stress on various components in the drive line. Thus, engineers are often seeking new ways of reducing the magnitude of torsional vibrations in order to reduce undesirable wear and extend the fatigue life of drive line components.

The present disclosure is directed toward one or more of the problems set forth above.

### SUMMARY

In one aspect, a variable stiffness torsional coupling includes a second coupler oriented to rotate with respect to a first coupler about an axis through a continuum of negative, neutral and positive torque orientations. One of the first coupler and second coupler includes a plurality of piston and barrel combinations in contact with another of the first coupler and the second coupler, and each of the piston and barrel combinations defines a variable volume chamber fluidly connected to a fluid transfer passage. A piston moves with respect to a barrel of each piston and barrel combination responsive to rotation of the first coupler relative to the second coupler to change a volume of the variable volume chamber. A pressure control device is used for controlling pressure of the fluid in the fluid transfer passage. An electronic controller is in control communication with the pressure control device and configured to execute a resonance avoidance algorithm to generate pressure control signals for the pressure control device. The rotational stiffness of the first coupler relative to the second coupler increases and decreases responsive to an increase and a decrease, respectively, of the pressure of the fluid.

In another aspect, a machine includes an engine with a drive shaft torsionally coupled to a work shaft of a driven device by a variable stiffness torsional coupling. The variable stiffness torsional coupling includes a first coupler attached to rotate with the drive shaft, and a second coupler attached to rotate with the work shaft. The second coupler is oriented to rotate with respect to the first coupler about an axis through a continuum of negative, neutral and positive torque orientations. One of the first coupler and second coupler includes a plurality of piston and barrel combinations in contact with an other of the first coupler and second coupler. Each piston and barrel combination defines a variable volume chamber fluidly connected to a fluid transfer passage, and a piston moves with respect to a barrel of each piston and barrel combination responsive to rotation of the first coupler relative to the second coupler to change a volume of the variable volume chamber. The variable stiffness torsional coupling also includes a pressure control device for controlling a pressure of a fluid in the fluid transfer passage. An electronic controller is in control communication with the pressure control device and configured to execute a resonance avoidance algorithm to generate pressure control signals for the pressure control device. A rotational stiffness of the first coupler relative to the second coupler increases and decreases responsive to the increase and a decrease, respectively of the pressure of the fluid.

In still another aspect, a method of driving rotation of a work shaft includes applying a torque from a drive shaft of an engine to the work shaft of a driven device through a variable stiffness torsional coupling. The applying step includes rotating a first coupler relative to a second coupler away from a neutral torque orientation. Engine speed is increased from zero toward an operational speed during an engine start up. A torsional resonance vibration is avoided during the engine start up by reducing a rotational stiffness of the variable stiffness torsional coupling responsive to an engine speed.

### BRIEF DESCRIPTION OF THE DRAWINGS

FIG. 1 is a schematic illustration of a machine according to one aspect of the present disclosure;

FIG. 2 is a partial front sectioned view of a variable stiffness torsional coupling according to another aspect of the present disclosure;

FIG. 3 is a side sectioned view of the variable stiffness torsional coupling of FIG. 2;

FIG. 4 is a partial front sectioned view of a piston and barrel combination for a variable stiffness torsional coupling according to another embodiment of the present disclosure;

FIG. 5 is a graph of torsional stiffness verses angular deflection for the variable stiffness torsional coupling of FIG. 2;

FIG. 6 is a graph of torque verses time for an engine start up for the machine of FIG. 1 for three different scenarios; and

FIG. 7 is a graph of engine speed verses time for the engine start up scenarios of FIG. 6.

### DETAILED DESCRIPTION

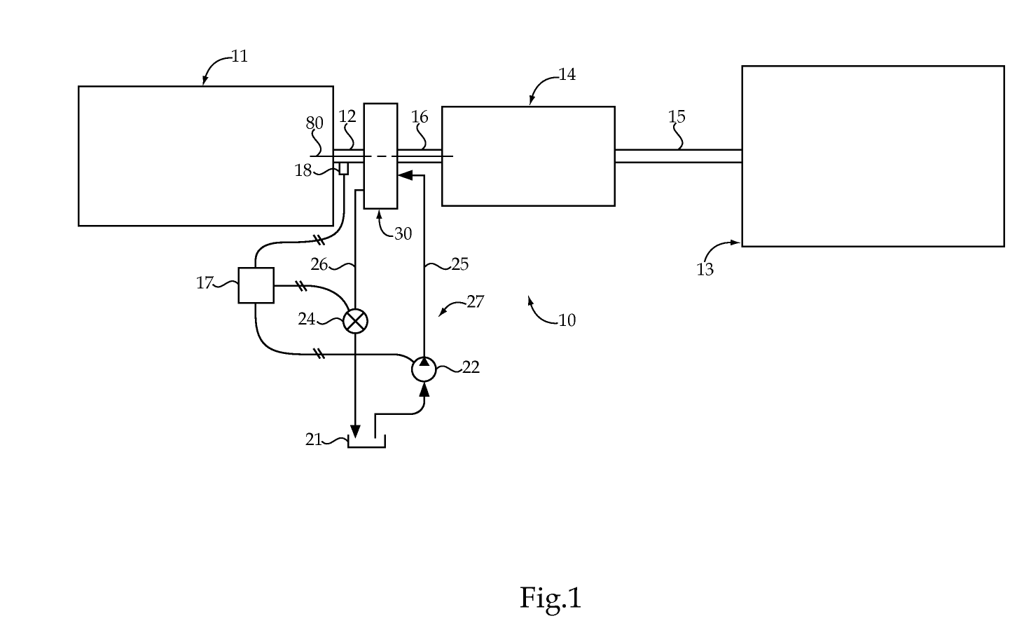

Referring to FIG. 1, a machine 10 according to one exemplary embodiment of the present disclosure is illustrated. Machine 10 may include an engine 11 with a drive shaft 12 operably coupled to drive rotation of a work shaft 15 of a driven component 13 by way of a variable stiffness torsional coupling 30 and a transmission/gear box 14. Driven equipment 13 could take on a wide variety of forms without departing from the present disclosure. Driven equipment 13 could be a portion of a fracture rig pumping machine 10, a propeller in the event that machine 10 were a marine application, an axle if machine 10 were a motor vehicle, etc. Torque from engine 11 is transmitted via drive shaft 12 through the variable stiffness torsional coupling 30 to an output shaft 16. In turn, shaft 16 can also be thought of as an input shaft for transmission/gear box 14 to drive rotation of work shaft 15. In the example embodiment, machine 10 may be a fracture rig pump application with driven equipment 13 being a hydraulic piston pump and work shaft 15 being a pump shaft. With or without transmission/gear box 14, drive shaft 12 may be thought of as being torsionally coupled to pump shaft 15 by variable stiffness torsional coupling 30.

Variable stiffness torsional coupling 30 includes an electronic controller 17 in control communication with a pressure control device 27. Electronic controller 17 is configured to execute a resonance avoidance algorithm to generate pressure control signals for the pressure control device 27. The pressure control device 27 controls the pressure of a damping fluid in the variable stiffness torsional coupling 30. The rotational stiffness of the variable stiffness torsional coupling increases and decreases responsive to an increase and a decrease, respectively of the pressure of the damping fluid.

The pressure control device 27 may include a source of damping liquid 21 fluidly connected to a pump 22, which supplies damping liquid to torsional coupling 30 via supply passage 25. A return passage 26 may include a valve 24. The electronic controller 16 may be in control communication with at least one of pump 22 and valve 24 for controlling pressure in variable stiffness torsional coupling 30. For instance, valve 24 might be a typical electronic clutch pressure control valve used in transmissions. Those skilled in the art will appreciate that although pump 22 and valve 24 are illustrated for regulating damping liquid pressure, many other known mechanisms and plumbing connections are known for controlling the pressure of a damping liquid. In the illustrated embodiment, the damping liquid might be lubricating oil or hydraulic fluid. However, other fluids, including gases would also fall within the scope of the present disclosure. In one variation, torsional coupling 30 could be configured in a way to be supplied with hydraulic transmission liquid from transmission 14, and have the supply being liquid pressure regulated in any manner known in the art without departing from the present disclosure.

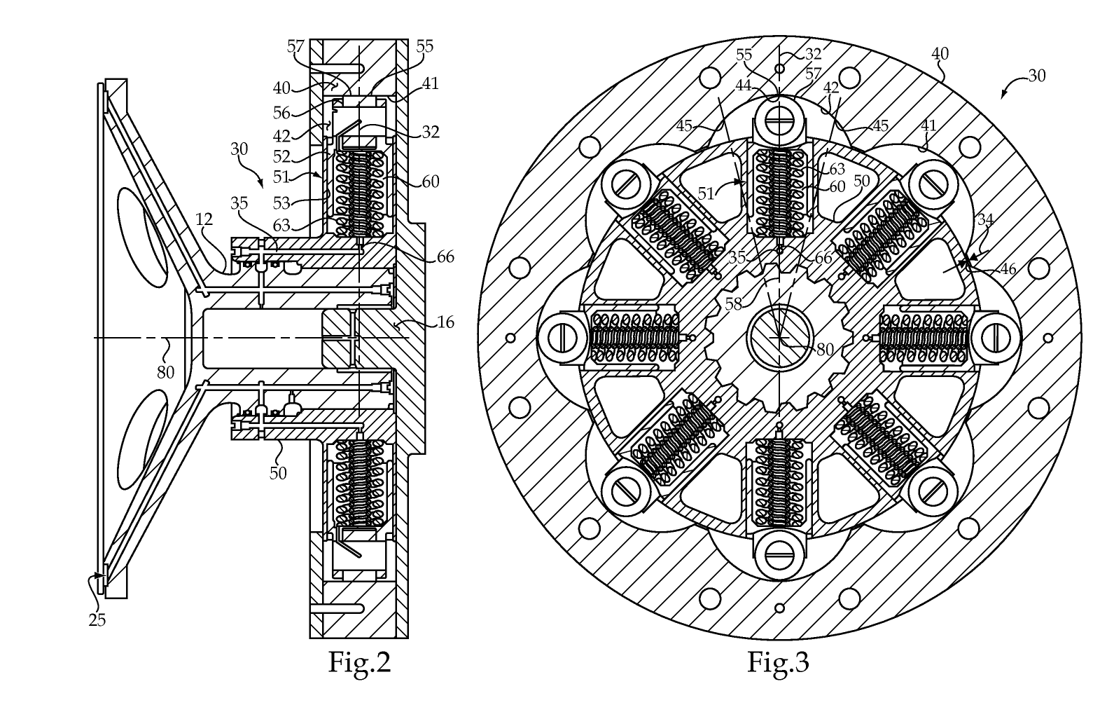

Referring in addition to FIGS. 2 and 3, variable stiffness torsional coupling 30 includes a first coupler 40 oriented to rotate with respect to a second coupler 50 about an axis 80 through a continuum of negative, neutral and positive torque orientations. In FIGS. 2 and 3, first and second couplers, 40, 50 are shown in their neutral torque orientations. The first coupler 40 may be linked to drive shaft 12 of engine 11 in a conventional manner, such as via rimbolts to a fly wheel. The second coupler 50 may be linked to pump shaft 15, such as via a spline and transmission 14. First coupler 40 may define an inwardly oriented fluted perimeter surface 41 with a number of flutes 42 that are distributed with radial symmetry about axis 80. In the illustrated embodiment, eight flutes 42 are distributed with radial symmetry about axis 80, and each flute 42 is separated by a radial stop 46. Second coupler 50 may include a number of piston and barrel combinations 51 equal to the number of flutes 42. In particular, piston and barrel combinations 51 each may include a piston 52 that is reciprocally received in a respective barrel 53 to define a variable volume chamber 60 fluidly connected to a fluid transfer passage 35 that is fluidly connected to supply passage 25 from pump 22, and may include a damping orifice 66 that may be sized to provide a desired amount of damping for damping liquid displaced therethrough responsive to movement of pistons 52 and barrels 53 to increase or decrease the volume of variable volume chamber 60. Thus each variable volume chamber 60 and fluid transfer passage 35 may be filled with damping liquid originating from damping liquid source 21, (FIG. 1). Pistons 52 move with respect to barrels 53 responsive to rotation at the first coupler 40 relative to the second coupler 50 to change a volume of the variable volume chamber 60. In the specific illustrated embodiment, each piston and barrel combination 51 has a centerline 58 aligned with a radius 32 that is perpendicular to axis 80. Other piston and barrel combinations 51 with different orientations fall within the scope of the present disclosure.

One or more mechanical springs 63 may be compressed in variable volume chamber 60, or elsewhere, to bias the pistons and barrels to extend toward a position where a contact end 55 is in contact with one of the flutes 42. In the illustrated embodiment, the barrels 53 are fixed with regard to second coupler 50, and the pistons 52 are biased responsive to two mechanical coil springs 63 to maintain contact between contact end 55 and fluted perimeter surface 41. The contact end 55 may be an edge 57 of a roller 56 that is attached to one end of each respective piston 52. Nevertheless, those skilled in the art will appreciate that the pistons could be fixed, and the barrels could be biased to move on the fixed pistons without departing from the present disclosure.

In the illustrated embodiment, each of the flutes 42 may be symmetrical about a radius 32 from axis 80, at a center 44 corresponding to an extended piston and barrel configuration, as shown. A pair of off center locations 45 correspond to a bottomed out piston and barrel configuration. Thus, FIGS. 2 and 3 show each piston and barrel combination 51 in their maximum extended position with contact end 55 in contact with flute 42 at center 44 of the respective flute, which corresponds to a neutral torque orientation. The off center points 45 identify the maximum angle of relative rotation permissible between first coupler 40 and second coupler 50 due to the fact that the pistons have bottomed out in their respective barrels 53, and may not retract any further. The off center points 45 may correspond to respective expected maximum positive and negative design torques for machine 10. Some applications may permit and even desire torque large enough to bottom out the piston and barrel combinations 51, whereas other applications may be designed so that the torques never, or almost never, result in the piston and barrel combinations 51 reaching one or both of the off center points 45. The mathematically continuous surface of the flutes 42 defines a continuum of positive, neutral and negative torque orientations between the first coupler and the second coupler 50. Those skilled in the art will appreciate that the individual flutes 42 need not necessarily be symmetric about the radius 32 from axis 80. For instance, a majority of the flute surface may be located on one side or the other of radius 32 from axis 80 to reflect a machine in which the average working torque transmitted through torsional coupling 30 is always positive or negative, depending upon the particular application.

Although not necessary, each of the flutes 42 may follow a non-circular contour, such as an ellipse or maybe even a super ellipse. Those skilled in the art will appreciate that the equation (x/a)ⁿ+(y/b)ⁿ=1 represents a family of closed curves. When the exponent n is between 0 and 1 the resulting curve looks like a four arm star with concave (inwardly curved) sides. When n is equal to 1, the curve becomes a diamond shape. When n is between 1 and 2, the super ellipse looks like a diamond with convex sides, and the curvature increases as one approaches the corners. When n=2, the curve is an ordinary ellipse, and becomes a circle if a=b. When n is greater than 2, the super ellipse shape begins to look more like a rectangle with sharper corners. In the illustrated embodiment, super ellipses with an exponent may be between 1.8 and 2 provide more torsional resistance (relative to a circle or ellipse) since the roller will almost immediately encounter a slope when moving off the neutral torque orientation corresponding to center 44. Those skilled in the art will appreciate that a wide variety of different torque relationships may be obtained by choosing an appropriate contour for the individual flutes 42. As used in the present disclosure, and in reference to the above equation, a super ellipse does not include a circle where a=b, nor does a super ellipse correspond to a situation when the exponent n=2.

Due to the radially symmetric distribution of piston and barrel combinations 51, along with the respective spring biasing 63, the first coupler 40 and the second coupler 50 are biased toward concentricity with respect to axis 80. However they may be off center displaceable to an eccentric distance 34 that is limited by a radial stop 46. In other words, the eccentric distance 34 corresponds to a radial clearance between first coupler 40 and second coupler 50, and the limitation corresponds to the situation when second coupler 50 contacts one or more of the radial stops 46. Thus, the structure of the present disclosure does permit some misalignment between the respective shafts that are attached to the first and second couplers. This aspect of the present disclosure also permits the two components (e.g. engine and pump) that are respectively linked to the first and second couplers 40, 50. Some lateral movement, such as due to linear vibrations and the like without overstressing the coupling arrangement. In the illustrated embodiment, mechanical springs 63 may be a pair of nested mechanical coil springs. However, those skilled in the art will appreciate that springs 63 could be eliminated and the necessary biasing be provided by a different spring, such as a stack of Belleville washers, a pneumatic spring or any combination thereof without departing from the scope of the present disclosure. In fact, the only biasing may come from a pressure of the fluid in the variable volume chamber 60.

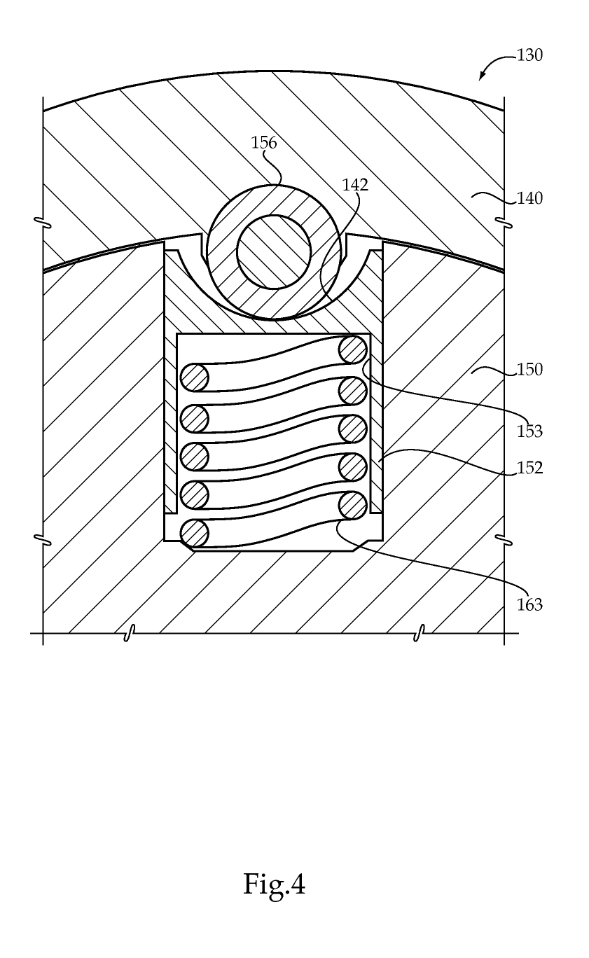

Although the variable stiffness torsional coupling 30 is illustrated with the fluted perimeter surface 41 being located on the outer component, namely first coupler 40, the flute perimeter surface 41 could instead be on the inner component and be an outwardly oriented fluted perimeter surface (resembling a Greek column) without departing from the present disclosure. In such a case, the piston and barrel combinations 51 will be biased radially inward, instead of radially outward as in the illustrated embodiment. Referring to FIG. 4, an alternative structure for a variable stiffness torsional coupling 130 differs from the earlier embodiment by having rollers 156 mounted to a first coupler 140, which piston 152 and barrels 153 are part of a second coupling 150. A mechanical spring 163 biases piston 152 and flute 142 into contact with roller 156. Flute 142 may follow the contour of a super ellipse.

Those skilled in the art will appreciate that engineers may design a variety of torsional coupling properties by adjusting the pressure of the damping liquid, by setting the pre-load on the mechanical biasing spring 63, if any, and also by taking into account the mass properties of the rotating components to account for torsional stiffness changes that may be attributable to the centrifugal force on the piston and barrel combinations 51 caused by rotational speed. In addition, the natural frequencies of machine 10 may also be adjusted by changing these parameters to change this torsional stiffness of coupling 30, which may inherently change in response to rotational speeds. Other design considerations may include a radius of rollers 56, the contour of the individual flutes 42, which could be irregular, as well as the number of piston and barrel combinations 51 and the associated number of flutes 42.

### INDUSTRIAL APPLICABILITY

The present disclosure finds potential application in any machine in which one rotating component drives rotation of a second rotating component. These two rotating components could be two shafts, as in the illustrated embodiment, a gear and a shaft, two gears, or any other similar structure known in the art without departing from the present disclosure. For instance, the outer surface of the outer coupler could include gear teeth for meshing with an adjacent gear that is driven to rotate by the outer coupler from a shaft length to the inner coupler. In the illustrated embodiment, the drive and driven shafts are co-linear. The torsional coupling 30 of the present disclosure finds particular application in heavy machinery, such as fracture rig applications, maybe in marine applications, and possibly in generator set applications.

When machine 10 is in operation, a torque is applied from a drive shaft 12 to a work shaft 16 through the variable stiffness torsional coupling 30. When the torque is applied, the first coupler 40 rotates relative to the second coupler 50 away from a neutral torque orientation, as shown. After settling in at a point on the fluted surface 41, a roller 56 of the second coupler 50 may roll back and forth in a non-circular flute 42 responsive to a torsional vibration. Thus, when drive shaft 12 is driving rotation of work shaft 15 with some average torque, the first coupler 40 and second coupler 50 will seek out a relative orientation that is stable at a specific point on the contour of the flute 42 corresponding to that average torque. When a torsional vibration is encountered, one could expect the first and second couplers to oscillate rotationally with respect to each other about that stable average torque point on the flute contour. In some instance, the torsional vibration may correspond to a natural or harmonic excitation frequency that can quickly grow exponentially. Some of the relative rotation may be damped by displacing liquid through damping orifice 66 into and out of variable volume chambers 60 responsive to the back and forth movement of the roller, and hence the in and out movement of the pistons 52 with respect to their barrels 53. The piston and barrel combination 51 may bottom out at a maximum design torque position corresponding to off center locations 45 shown in FIG. 2. In general, the off center locations 45 may be designed beyond the expected maximum torque, or the expected maximum resonance vibration magnitude to be encountered for a given machine application.

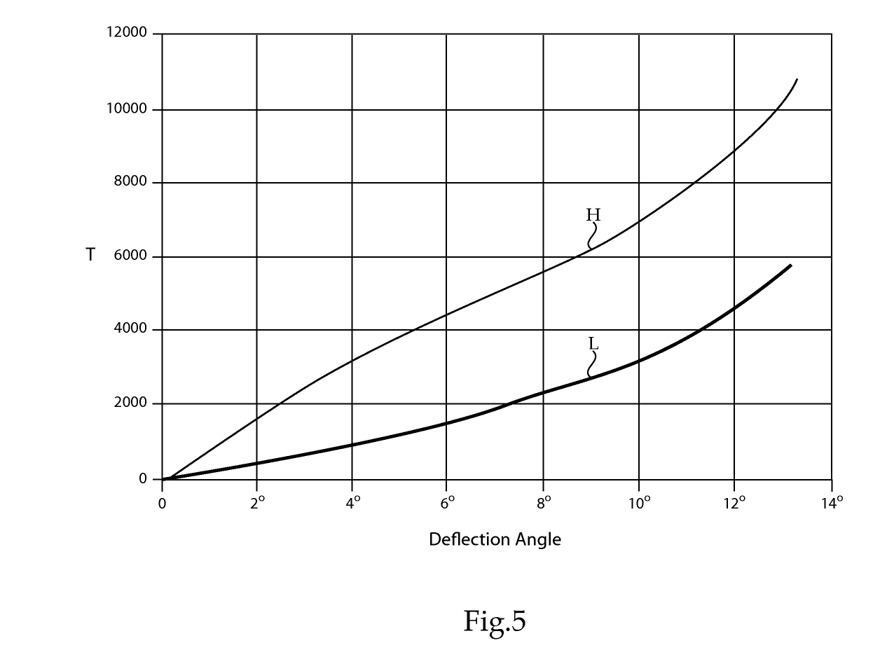

In some applications, the non-circular flute 42 may follow the contour of a super ellipse as described earlier. In the illustrated embodiment, each of the flutes 42, occupies about 30-40% of an associated super ellipse closed contour. The torsional stiffness of the variable stiffness torsional coupling 30 may be changed by changing a supply pressure of the liquid damping fluid using the pressure control device 27 as controlled by electronic controller 16 executing a resonance avoidance algorithm. Those skilled in the art will appreciate that any known strategy for controlling pressure of the damping liquid in the variable volume chambers would fall within the scope of the present disclosure. For instance, FIG. 5 shows an example of how the torsional stiffness of the illustrated coupling 30 varies when a pressure is high H and when the pressure of the damping liquid is low L for a variety of deflection angles between the first coupler 40 and the second coupler 50. Although the drive shaft 12 and work shaft 16 may be preferably concentric, the illustrated embodiment tolerates the eccentric off center relationship limited by radial stops 46.

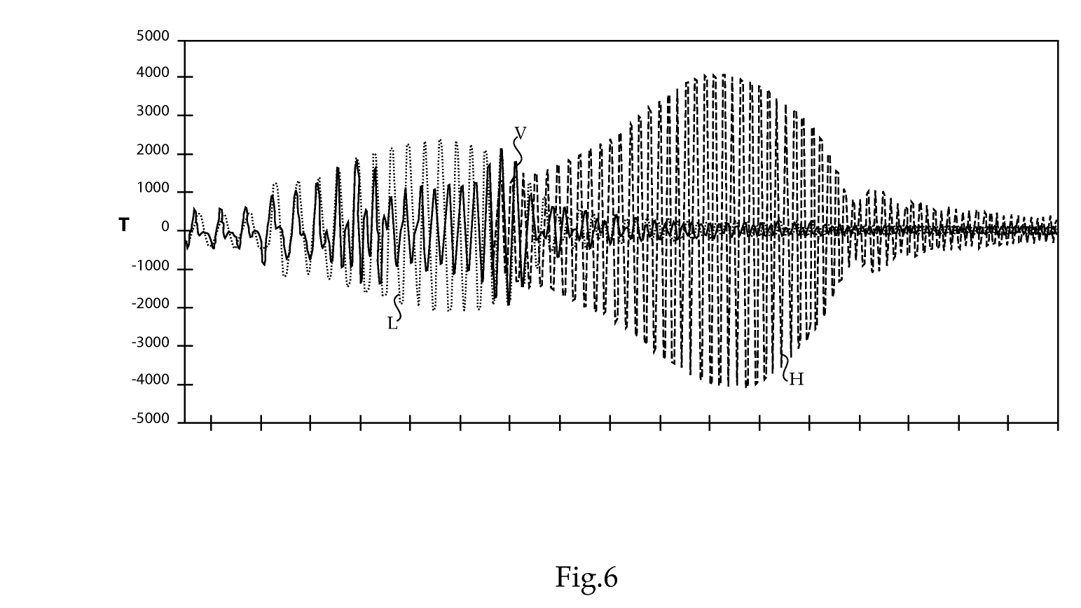

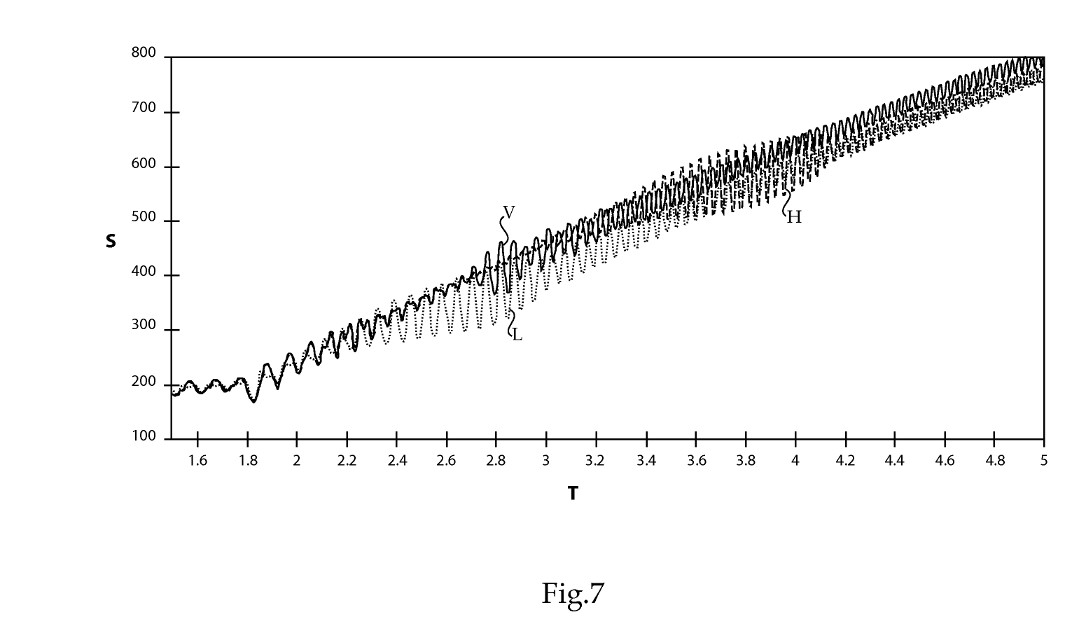

One strategy for developing a resonance avoidance algorithm for a given machine 10 is to recognize where a torsional resonance might exist. For instance, identification of a potential torsional resonance may be accomplished by knowing the coupling speed, potential transmission gears, and the key excitation harmonic. Optionally, some software parameters may be available that can monitor dynamic speeds across a coupling. Next, one might wish to know if the system is accelerating or decelerating toward a resonance position. For example, referring now in addition to FIGS. 6 and 7, the present disclosure is applied to a common problem for torsionally soft coupling systems, that occur at engine start up. Three different scenarios are illustrated in FIGS. 6 and 7. First, one line shows the torque magnitude oscillation at engine start up for low pressure L. (soft coupling). A second line shows the torque oscillation in coupling 30 when the damping pressure liquid pressure is high H. (stiff coupling). FIG. 6 shows that in one example application, the system must pass through a resonance condition at engine start up, but that resonance condition occurs at different engine speeds depending upon whether the pressure of the damping liquid is low L or high H. Current strategies may call for quickly accelerating through the resonance condition in the hopes that the torsional vibration magnitude excitation can be manageable allowing the magnitude to be limited and then quickly damped after engine speed moves passed the resonant speed. The curve V represents application of a resonance avoidance algorithm in the form of an engine start up algorithm that is configured to command a pressure decreased control signal to the pressure control device 27 responsive to an engine speed signal, which may be communicated to electronic controller 17 by a speed sensor 18 (FIG. 1). In this example, curve V represents when pressure control device 27 feeds the coupling 30 at a relatively high pressure as the engine 11 initially accelerates. At a certain interval, or triggered by the engine speed relative to the torsional resonance, the pressure control device 27 is commanded by electronic controller 17 for a sudden pressure drop. The idea is to avoid a high fly wheel speed oscillation of a soft (low pressure system curve L) which can compromise starting ability, but then avoid the high torque generated by a stiffer (high pressure curve H) torsional system by shifting to the soft condition once the engine speed is above the soft system resonance speed shown by curve L. This strategy can improve startability as well as effectively limit the peak torques the coupling 30 and other drive line elements will be exposed to. In other words, curve V shows torque oscillations substantially smaller than either the extreme magnitudes of the curve L or the curve H, simply by starting with a relatively high pressure as the engine accelerates and then suddenly dropping to a lower pressure after engine speed exceeds the resonance associated with the softer system. FIG. 7 shows engine speed during a portion of engine start up verses time on the same scale of FIG. 6 for each of the different damping fluid pressure L, H and V.

Another potential situation where a resonance avoidance algorithm could be developed would be to identify resonance conditions during an engine misfire, such as one or two cylinders not firing due to a failed fuel injector. This is again a common challenge for soft couplings as these torsional resonances may typically occur at a higher operating speed range, but may not be a problem at all when all cylinders are firing correctly. In such a case, the resonance avoidance algorithm may need to recognize that the misfire issue has arisen from speed sensors ahead of or after the torsional coupling, and take appropriate pressure changes to shift the resonance speed away from the current operating speed, and potentially do a similar transition if speed continues to approach a resonance. Those skilled in the art will appreciate that at engine start up, engine speed accelerates from zero toward an operational speed.

In a closed loop application, if speed was increasing, a controller could monitor speed and phase of the two devices, such as the engine crankshaft and the pump shaft. As the magnitude and phase were to grow increasingly of concern, the response would be to decrease pressure to move the resonance from being ahead at a higher speed to behind at a lower speed. The concern would be making sure that the pressure change was sufficient that the pressure change did not land the resonance at the speed the machine is currently at, which could be very undesirable. Likewise, if speed were decreasing and the magnitude and phase of the torsional vibration between the two shafts were growing increasingly, the response might be to increase stiffness to move the resonance behind the current speed or to a higher speed so that as the machine continued to decrease in speed the machine would move farther from the resonance.

It might be possible to change the apparent stiffness beyond the actual stiffness of the torsional coupling. In other words, by precisely timing pressure increase pulses frequency, the apparent stiffness of the coupling can be made far larger than its actual stiffness. This strategy might be utilized to leverage pressure control beyond that available by a simple step change in pressure.

The torsional coupling of the disclosure becomes increasingly stiff in transmitting torque from centrifugal force as speed increases. Thus, pressure changes at higher speeds may have a lesser effect on mass properties than they do at lower speeds. Thus, if a problem that could not be adequately dealt with at higher speeds were to be observed, the response might be to make the pistons lighter so that the centrifugal force aspect would be decreased, and/or resort to pressure pulsations to leverage the apparent stiffness aspect of the present disclosure in order to address a problem at higher speeds using pressure change in the torsional coupling as a control tool.

Another application of the present disclosure might be to actively change pressure in concert with a harmonic excitation to make a coupling behave extremely soft. For instance, if one had a drive line with significant speed oscillations, the mean torque being delivered through variable stiffness torsional coupling 30 of the present disclosure could absorb the oscillations, and transmit an almost constant torque at nearly constant speed. To do so, one might need to have the ability to modify the damping fluid pressure at or close to the frequency of an oscillation. A mechanism that responds to drive side accelerations may well provide inherent control of such a system. High pressure may need to correspond to low acceleration, while lower pressure might correspond to higher acceleration points in a harmonic cycle. The engine start up algorithm discussed above with regard to the resonance avoidance algorithm might be operative in reverse when the engine is proceeding to a shut down configuration. Thus, in the engine start up algorithm for the resonance avoidance algorithm, a torsional resonance vibration may be reduced during the engine start up by reducing the rotational stiffness of the variable stiffness torsional coupling 30 responsive to an engine speed in one simple application of the present disclosure.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A variable stiffness torsional coupling comprising:
a first coupler;
a second coupler oriented to rotate with respect to the first coupler about an axis through a continuum of negative, neutral and positive torque orientations;
one of the first coupler and second coupler including a plurality of piston and barrel combinations in contact with an other of the first coupler and the second coupler, and each of the piston and barrel combinations defining a variable volume chamber fluidly connected to a fluid transfer passage;
a piston moves with respect to a barrel of each piston and barrel combination responsive to rotation of the first coupler relative to the second coupler to change a volume of the variable volume chamber;
a pressure control device for controlling a pressure of the fluid in the fluid transfer passage;
an electronic controller in control communication with the pressure control device and configured to execute a resonance avoidance algorithm to generate pressure control signals for the pressure control device; and
wherein a rotational stiffness of the first coupler relative to the second coupler increases and decreases responsive to an increase and a decrease, respectively, of the pressure of the fluid.

2. The variable stiffness torsional coupling of claim 1 wherein the variable volume chamber and the fluid transfer passage are filled with a liquid.

3. The variable stiffness torsional coupling of claim 1 including at least one compressed mechanical spring in each of the variable volume chambers.

4. The variable stiffness torsional coupling of claim 1 wherein each of the piston and barrel combinations has a centerline aligned with a radius perpendicular to the axis.

5. The variable stiffness torsional coupling of claim 1 wherein the resonance avoidance algorithm includes an engine startup algorithm configured command a pressure decrease control signal responsive to an engine speed signal.

6. The variable stiffness torsional coupling of claim 5 wherein the variable volume chamber and the fluid transfer passage are filled with a liquid; and
at least one compressed mechanical spring in each of the variable volume chambers.

7. The variable stiffness torsional coupling of claim 6 wherein each of the piston and barrel combinations has a centerline aligned with a radius perpendicular to the axis.

8. A machine comprising:
an engine with a drive shaft;
a driven device with an work shaft;
the drive shaft being torsionally coupled to the work shaft by a variable stiffness torsional coupling;
the variable stiffness torsional coupling including a first coupler attached to rotate with the drive shaft, and a second coupler attached to rotate with the work shaft, and the second coupler being oriented to rotate with respect to the first coupler about an axis through a continuum of negative, neutral and positive torque orientations, and one of the first coupler and the second coupler including a plurality of piston and barrel combinations in contact with an other of the first coupler and the second coupler, and each of the piston and barrel combinations defining a variable volume chamber fluidly connected to a fluid transfer passage, and a piston moves with respect to a barrel of each piston and barrel combination responsive to rotation of the first coupler relative to the second coupler to change a volume of the variable volume chamber, and further including a pressure control device for controlling a pressure of a fluid in the fluid transfer passage;
an electronic controller in control communication with the pressure control device and configured to execute a resonance avoidance algorithm to generate pressure control signals for the pressure control device; and
wherein a rotational stiffness of the first coupler relative to the second coupler increases and decreases responsive to an increase and a decrease, respectively, of the pressure of the fluid.

9. The machine of claim 8 wherein the variable volume chamber and the fluid transfer passage are filled with a liquid.

10. The machine of claim 8 including at least one compressed mechanical spring in each of the variable volume chambers.

11. The machine of claim 8 wherein each of the piston and barrel combinations has a centerline aligned with a radius perpendicular to the axis.

12. The machine of claim 8 wherein the resonance avoidance algorithm includes an engine startup algorithm configured to command a pressure decrease control signal responsive to an engine speed signal.

13. The machine of claim 12 wherein the variable volume chamber and the fluid transfer passage are filled with a liquid; and
at least one compressed mechanical spring in each of the variable volume chambers.

14. The machine of claim 13 wherein each of the piston and barrel combinations has a centerline aligned with a radius perpendicular to the axis.

15. The machine of claim 14 wherein the engine and the driven device, which includes a hydraulic piston pump, are portions of a fracture rig.

16. A method of driving rotation of a work shaft, comprising the steps of:
applying a torque from a drive shaft of an engine to the work shaft of a driven device through a variable stiffness torsional coupling;
the applying step includes rotating a first coupler relative to a second coupler away from a neutral torque orientation;
increasing engine speed from zero toward an operational speed during an engine start up; and
reducing a torsional resonance vibration during the engine start up by reducing a rotational stiffness of the variable stiffness torsional coupling responsive to an engine speed.

17. The method of claim 16 wherein the reducing step includes reducing a fluid pressure in a fluid transfer passage fluidly connected to a plurality of variable volume chambers of the variable stiffness torsional coupling.

18. The method of claim 17 including a step of biasing the first coupler toward a neutral torque orientation with respect to the second coupler.

19. The method of claim 18 wherein the biasing step includes pressurizing the fluid and compressing a mechanical spring in the variable volume chamber.

20. The method of claim 19 wherein a piston moves with respect to a barrel along a radius perpendicular to the axis responsive to rotation of the first coupler relative to the second coupler.
